(19) United States
(12) Patent Application Publication
(10) Pub. No.: US 2010/0047526 A1
(43) Pub. Date: Feb. 25, 2010

(54) SUBSURFACE INCLUSIONS OF SPHEROIDS AND METHODOLOGY FOR STRENGTHENING A SURFACE BOND IN A HYBRID CERAMIC MATRIX COMPOSITE STRUCTURE

(76) Inventors: Gary B. Merrill, Orlando, FL (US); Jay A. Morrison, Oviedo, FL (US); H. Lee Brobst, Longwood, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/194,135

(22) Filed: Aug. 19, 2008

(51) Int. Cl. B32B 3/22; B29C 70/02

(52) U.S. Cl. 428/163; 427/199

(57) ABSTRACT

Structural arrangements and methodology are provided for strengthening a bond between corresponding surfaces of a thermally insulating ceramic coating (14) and a ceramic matrix composite substrate (12). A subsurface inclusion of spheroid objects allows to influence a texture of an outer surface of the CMC substrate to enhance the bonding characteristics between the corresponding surfaces.

### FIELD OF THE INVENTION

The present invention is generally related to ceramic structures for use in a high temperature combustion environment, and, more particularly, to structural arrangements and techniques for strengthening a surface bond between corresponding surfaces of an insulating ceramic coating and ceramic matrix composite (CMC) substrate, which is thermally protected by the ceramic coating.

### BACKGROUND OF THE INVENTION

Engine components in the hot gas flow of modern combustion turbines are required to operate at ever-increasing temperatures as engine efficiency requirements continue to advance. Ceramics typically have higher heat tolerance and lower thermal conductivities than metals, particularly in the case of oxide-based ceramic materials. For this reason, ceramics have been used both as structural materials in place of metallic materials and as coatings for both metal and ceramic structures. Ceramic matrix composite (CMC) wall structures with ceramic insulation outer coatings, such as described in commonly owned U.S. Pat. No. 6,197,424, have been developed to provide components with the high temperature stability of ceramics without the brittleness of monolithic ceramics.

The versatility of an insulated CMC material may be influenced by the strength of the bond between the insulation and the structural CMC material. For example, some environments and/or engine components may require an incremental bonding strength relative to a baseline bond strength. Accordingly, further improvements that increment the bonding strength between the insulation and the structural CMC material are desired.

### BRIEF DESCRIPTION OF THE DRAWINGS

The invention is explained in the following description in view of the drawings that show:

FIG. 1 is a partial cross-sectional view of a hybrid ceramic structure for use in a high temperature combustion environment.

FIG. 2 is an isometric view of an arrangement of successive layers of ceramic fibers in a CMC substrate and further illustrates an example arrangement of a plurality of spheroid objects that may be disposed on at least one of the plurality of layers.

FIG. 3 is an isometric view of an example textural characteristic on the outer surface of the ceramic substrate that may result from the geometric arrangement of the spheroid objects shown in FIG. 2.

FIG. 4 is an isometric view of an example textural characteristic on the outer surface of the ceramic substrate that may result from a random arrangement of the spheroid objects.

FIG. 5 is a comparative plot of examples of enhanced bonding strength, as obtained in accordance with aspects of the present invention, relative to a baseline bonding strength.

FIG. 6 is an isometric view of another example textural characteristic on the outer surface of the ceramic substrate that may result from a hexagonal arrangement of the spheroid objects.

### DETAILED DESCRIPTION OF THE INVENTION

FIG. 1 is a partial cross-sectional view of a finished hybrid ceramic structure 10 for use in a high temperature combustion environment, such as in a gas turbine engine. The hybrid ceramic structure 10 is formed of a substrate 12 of an oxide-based ceramic matrix composite (CMC) material that is thermally protected by a thermally-insulating ceramic coating 14. The ceramic matrix composite substrate 12 and ceramic coating 14 may be of the type described in U.S. Pat. No. 6,013,592, incorporated by reference herein. The ceramic matrix composite substrate 12 includes at least one layer of ceramic fibers beneath a surface of the substrate. Ceramic coating 14 may be an oxide-based ceramic including a matrix material 16 surrounding a plurality of mullite (or alumina rich mullite) 18 geometric shapes (e.g., spheres). The matrix material 16 may include a mullite or alumina rich mullite filler powder and a phosphate binder or an alumina filler powder and an alumina binder. One or more optional oxide bond layers (not shown) may be disposed between the ceramic matrix composite substrate 12 and the ceramic insulating coating 14 and may comprise one or more of the group of mullite, alumina, and zirconia or other stable oxide materials of similar range coefficients of thermal expansion.

The inventors of the present invention propose structural arrangements and techniques conducive to strengthening a surface bond between corresponding surfaces of insulating ceramic coating 14 and CMC substrate 12. Aspects of the present invention propose an innovative subsurface inclusion of spheroid objects that influence a texture of the bonding surface to enhance the bonding characteristics between such surfaces.

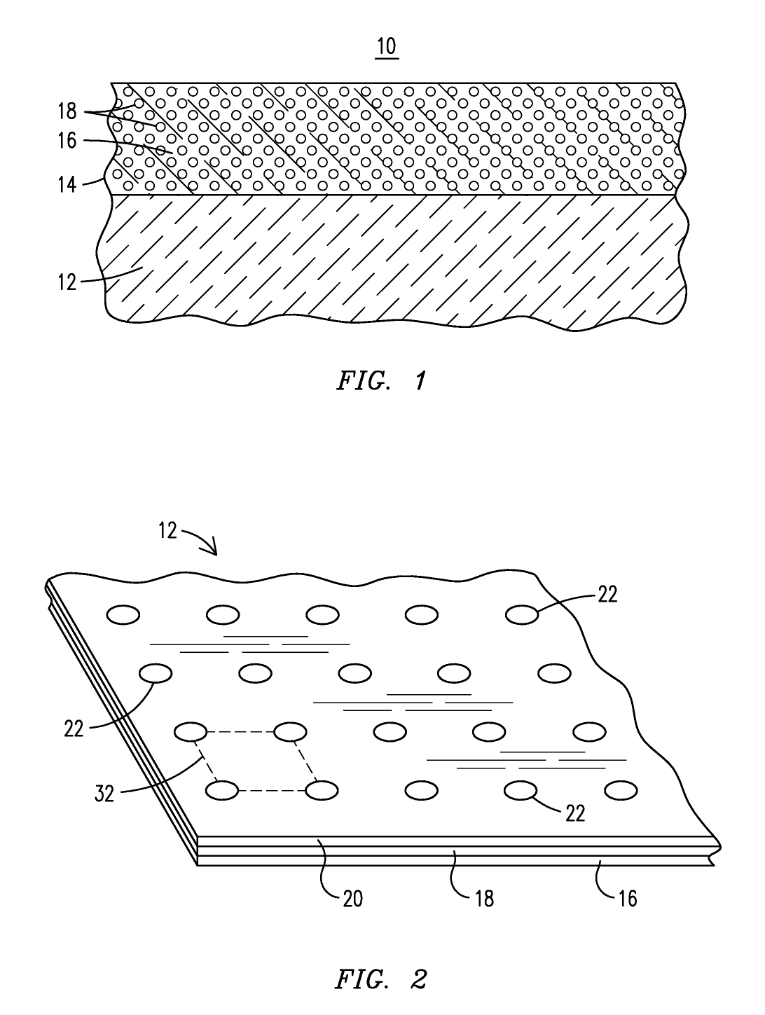

As shown in FIG. 2, CMC substrate 12 may be formed of a plurality of layers of ceramic fibers, such as layers 16, 18, and 20 and one or more subsequent layers (not shown in FIG. 2) yet to be disposed over layer 20 to form a layering arrangement of successive layers of ceramic fibers. A plurality of spaced apart spheroid objects 22 may be disposed on at least one of the plurality of layers, e.g., layer 20. In one example, the spheroid objects may be spheres, ellipsoids, and objects free of corners, such as hollow or partially-filled oxide-based shapes that may provide a selected degree of compressibility to the objects. For readers desirous of general background information in connection with examples of spheroids reference is made to U.S. Pat. No. 7,067,181, titled “Insulating Ceramic Based On partially-filled Shapes”, which is assigned to the same assignee of the present invention and is herein incorporated by reference. The spheroids may comprise different physical characteristics, such as different size, different thicknesses for their outer skins, different materials, and different shapes.

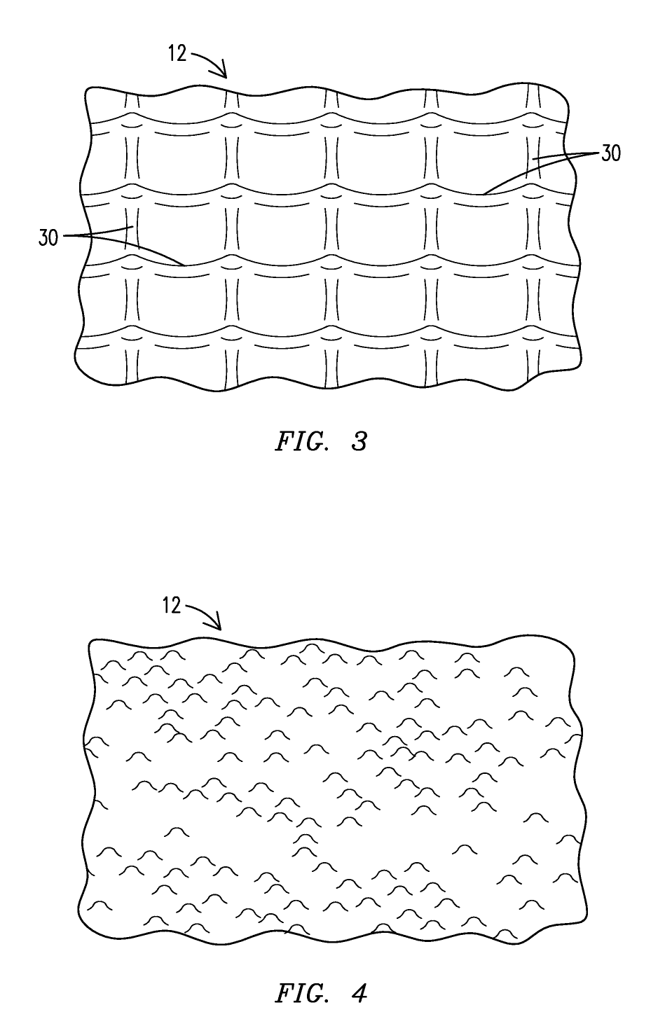

An outer surface of a subsequent layer to be disposed over the layer with the spheroid objects influences a texture of the outer surface of CMC substrate 12 by defining a plurality of corrugations 30 on the outer surface of the substrate, as may be appreciated on FIG. 3. For example, one or more subsequent layers may be subjected to a suitable pressurization (or vacuuming) action relative to the layer with the objects to ensure a compact joining of the objects between such layers. This may also provide effective infiltration to a slurry media, as may be used to fill any voids that may be created by the presence of the objects between the layers. It will be appreciated that the outer surface of the subsequent layer may be (but need not be) the outer surface of the substrate.

Subsequent to forming the substrate surface corrugations in this manner, the ceramic coating may be deposited on the outer surface of the ceramic substrate, and the plurality of corrugations 30 constitutes a bond-enhancing arrangement between the outer surface of the ceramic substrate and a corresponding boundary of the coating. As will be appreciated by one skilled in the art, the ceramic coating is generally applied upon completion of various customary preliminary substrate processing steps—e.g., after substrate drying, partial curing, tooling removal and/or partial sintering.

In this example embodiment, the spaced apart objects are distributed over layer 20 with a geometric arrangement configured to produce a unique textural characteristic to the outer surface of the ceramic substrate. By way of example, the geometric arrangement may be arranged as a plurality of parallelograms and respective ones of the spaced apart objects 22 are distributed over respective corners of the plurality of parallelograms. Examples of this type of geometric arrangement may include a rhomboid, a square and a rectangle. Another example of the geometric arrangement may be a plurality of polygons and respective ones of the spaced apart objects 22 are distributed over respective corners of the plurality of polygons.

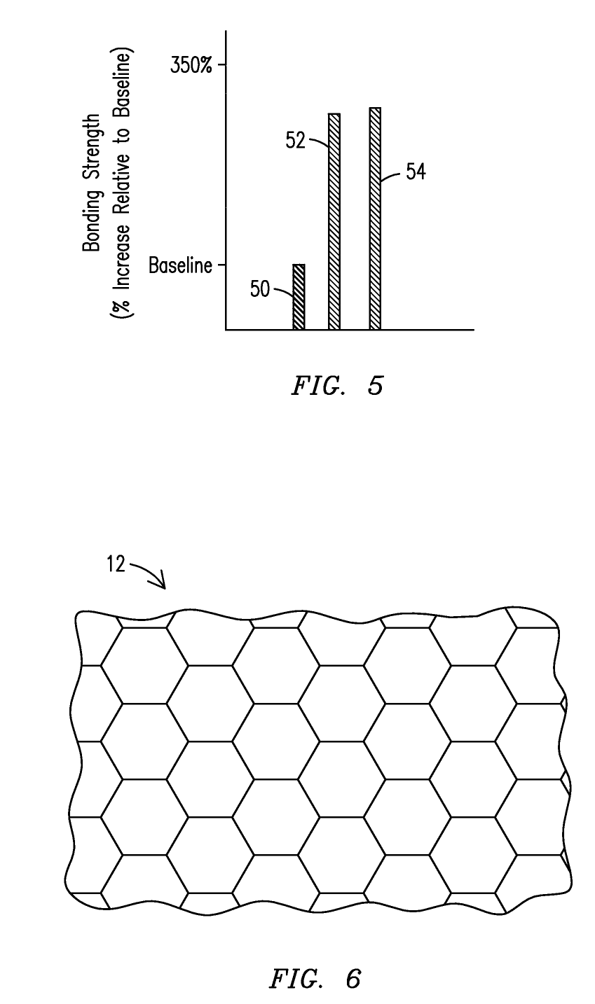

FIG. 2 shows example parallelograms 32 corresponding to square geometrical arrangements. FIG. 3 illustrates an example of a unique textural characteristic (e.g., a waffle-like texture) that results from the geometric arrangement illustrated in FIG. 2. It will be appreciated by those skilled in the art that other geometrical arrangements will produce other unique textural characteristic on the outer surface of the ceramic substrate. For example, it is contemplated that a hexagonal geometrical arrangement may produce a honeycomb-shaped textural characteristic on the outer surface of the ceramic substrate, as illustrated in FIG. 6.

In another example embodiment, the spaced apart objects may be distributed over one of the underlying fiber layers with a random arrangement. An example textural characteristic on the outer surface of the ceramic substrate that may result from such a random arrangement of the spheroid objects may be appreciated in FIG. 4.

It will be appreciated that the plurality of spaced apart spheroid objects need not be arranged on a single layer, as described above in the context of FIG. 2. For example, the plurality of spheroid objects may be arranged on at least two different layers. In an example case where one had previously arranged a first group of spheroid objects in layer 16, then spheroid objects 22 on layer 20 would constitute a group of spheroid objects disposed on a layer different than layer 16. This arrangement would be performed, after laying at least one layer of ceramic fibers (e.g., layer 18) onto the layer (e.g., layer 16) with the first group of objects.

FIG. 5 is a comparative plot of examples of enhanced bonding strength, as obtained in accordance with aspects of the present invention, relative to a known baseline bonding strength represented by bar 50. Bar 52 represents an example of enhanced bonding strength obtained when using the example geometric arrangement illustrated in FIG. 2 for the spheroid objects. Bar 54 represents an example of enhanced bonding strength obtained when using a random arrangement for the objects.

While various embodiments of the present invention have been shown and described herein, it will be understood that such embodiments are provided by way of example only. Numerous variations, changes and substitutions may be made without departing from the invention herein. Accordingly, it is intended that the invention be limited only by the spirit and scope of the appended claims.

1-11. (canceled)

12. A hybrid ceramic matrix composite structure, comprising:
a ceramic matrix composite substrate including a plurality of layers of ceramic fibers;
a first plurality of spaced apart spheroid objects disposed on at least one of the plurality of layers, wherein an outer surface of a subsequent layer disposed over said at least one of the plurality of layers with the spheroid objects influences a texture of the outer surface of the substrate by defining a plurality of corrugations on the outer surface of the substrate; and
a ceramic coating deposited on the outer surface of the substrate, wherein the plurality of corrugations constitutes a bond-enhancing arrangement between the outer surface of the substrate and a corresponding boundary of the coating.

13. The structure of claim 12, wherein the outer surface of the subsequent layer is the outer surface of the substrate.

14. The structure of claim 12, wherein the spaced apart objects are distributed on said at least one of the layers with a geometric arrangement.

15. The structure of claim 14, wherein the geometric arrangement comprises a plurality of parallelograms and the spaced apart objects are positioned at a plurality of corners defined by the plurality of parallelograms.

16. The structure of claim 15, wherein the plurality of parallelograms are selected from the group consisting of a rhombus, a square and a rectangle.

17. The structure of claim 14, wherein the geometric arrangement comprises a plurality of polygons and the spaced apart objects are positioned at a plurality of corners defined by the polygons.

18. The structure of claim 12, wherein the plurality of spheroid objects are arranged on at least two different layers.

19. The structure of claim 18, wherein the spaced apart objects are distributed over said at least two different layers with a geometric arrangement.

20. The structure of claim 12, wherein the spaced apart objects are distributed over said at least one of the layers with a random arrangement.

21. The structure of claim 18, wherein the spaced apart objects are distributed over said at least two different layers with a random arrangement.

22. The structure of claim 12, wherein the spheroid objects are selected from the group consisting of a sphere, an ellipsoid, and an object free of corners.

23. The structure of claim 12, wherein the plurality of spheroid objects comprise hollow oxide-based spheres.

24. The structure of claim 12, wherein the plurality of spheroid objects comprise partially filled oxide-based spheres.

25. The structure of claim 12, wherein the plurality of spheroid objects comprise spheres of different dimensions.
